(19) United States
(12) Patent Application Publication
(10) Pub. No.: US 2003/0213350 A1
(43) Pub. Date: Nov. 20, 2003

(54) Circular saw having workpiece clamping device

(76) Inventor: Chin-Chin Chang, Taichung Hsien (CN)

Correspondence Address: Connolly Bove Lodge & Hutz LLP, P.O. Box 2207, Wilmington, DE, 19899-2207, US

(21) Appl. No.: 10/150,741

(22) Filed: May 16, 2002

(51) Int. Cl. B26D 7/02; B26D 1/14

(52) U.S. Cl. 83/477.1; 83/452

(57) ABSTRACT

A circular saw having a workpiece clamping device includes a base secured with a fixing seat, and an adjusting threaded rod. The fixing seat is formed with a hollow receiving chamber. A press block is movably mounted in the receiving chamber, and is formed with an oblong hole which has a bottom formed with a semi-circular thread. The adjusting threaded rod is extended through the fixing seat and the oblong hole of the press block. The adjusting threaded rod normally meshes with the thread of the oblong hole of the press block. Thus, the adjusting threaded rod may be moved freely and quickly to move to a determined position, and may also be micro-adjusted at a slower speed.

### BACKGROUND OF THE INVENTION

1. Field of the Invention

The present invention relates to a circular saw having a workpiece clamping device, and more particularly to a circular saw having a workpiece clamping device, wherein the adjusting threaded rod may be moved freely and quickly to move to a determined position, and may also be micro-adjusted at a slower speed, so that the adjusting threaded rod may be operated rapidly and may be micro-adjusted exactly, so as to urge the workpiece to be cut.

2. Description of the Related Art

A conventional circular saw in accordance with the prior art comprises a base having two sides each provided with an extension side plate. A catch plate is slidably mounted on the top face of the extension aside plate, for catching the workpiece to be cut. However, the conventional circular saw is not provided with a workpiece clamping device between the base and the catch plate, for clamping the workpiece, so that the workpiece is easily displaced due to vibration, thereby affecting the cutting process of the conventional circular saw.

### SUMMARY OF THE INVENTION

The present invention has arisen to mitigate and/or obviate the disadvantage of the conventional circular saw.

The primary objective of the present invention is to provide a circular saw having a workpiece clamping device, so that the workpiece may be clamped rigidly and stably, thereby facilitating the user cutting the workpiece.

Another objective of the present invention is to provide a circular saw having a workpiece clamping device, wherein the adjusting threaded rod may be moved freely and quickly in a reciprocating manner to move to a determined position, and may also be micro-adjusted at a slower speed, so that the adjusting threaded rod may be operated rapidly and may be micro-adjusted exactly, so as to urge the workpiece to be cut.

In accordance with the present invention, there is provided a circular saw having a workpiece clamping device, comprising a base having a top face secured with a fixing seat, and an adjusting threaded rod extended through the fixing seat, wherein:

the fixing seat is formed with a hollow receiving chamber, a press block is movably mounted in the receiving chamber of the fixing seat, and is formed with an oblong hole, the oblong hole of the press block has a bottom formed with a semi-circular thread; and

the adjusting threaded rod is extended through the fixing seat, and is extended through the oblong hole of the press block, the adjusting threaded rod normally meshes with the thread of the oblong hole of the press block.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a circular saw having a workpiece clamping device in accordance with a preferred embodiment of the present invention;

FIG. 2 is an exploded perspective view of the workpiece clamping device of the circular saw as shown in FIG. 1;

FIG. 3 is a side plan cross-sectional assembly view of the workpiece clamping device of the circular saw as shown in FIG. 2;

FIG. 4 is a schematic operational view of the workpiece clamping device of the circular saw as shown in FIG. 3; and

FIG. 5 is a schematic operational view of the workpiece clamping device of the circular saw as shown in FIG. 4.

### DETAILED DESCRIPTION OF THE INVENTION

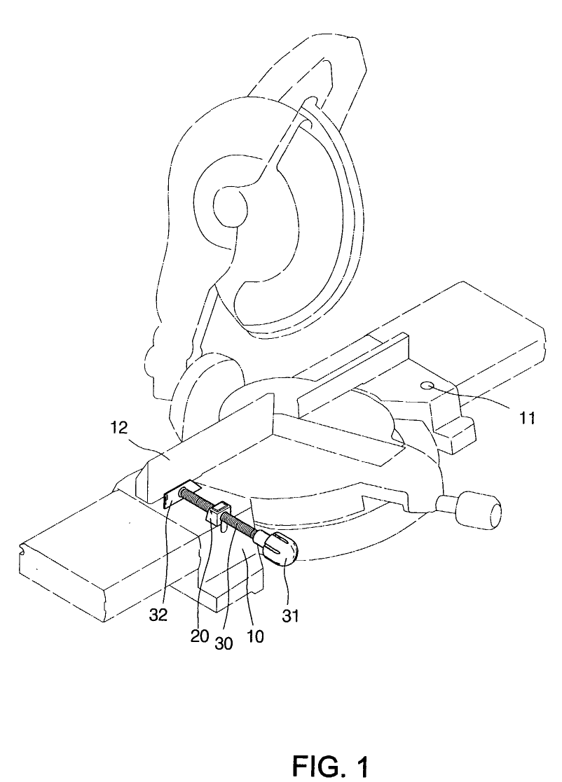

Referring to the drawings and initially to FIGS. 1-3, a circular saw having a workpiece clamping device in accordance with a preferred embodiment of the present invention comprises a base 10 having a top face having two sides each formed with a circular hole 11 for securing a fixing seat 20. The fixing seat 20 is provided with an adjusting threaded rod 30 which is extended through the fixing seat 20.

The fixing seat 20 has a bottom provided with a positioning column 21 secured in the circular hole 11 of the base 10. The fixing seat 20 has a front end secured with a clamp plate 22 for clamping the fixing seat 20 on a front wall of the base 10.

The fixing seat 20 is formed with a hollow receiving chamber 23. The fixing seat 20 has two side walls each formed with a shaft hole 24 communicating with the receiving chamber 23.

A press block 26 is movably mounted in the receiving chamber 23 of the fixing seat 20, and is longitudinally formed with an oblong hole 27 aligning with the shaft hole 24 of each of the two side walls of the fixing seat 20. The oblong hole 27 of the press block 26 has a bottom half formed with a semi-circular thread 28.

A spring 25 is mounted in the receiving chamber 23 of the fixing seat 20, and is biased between the press block 28 and a wall of the receiving chamber 23 of the fixing seat 20.

The adjusting threaded rod 30 is extended through the shaft hole 24 of each of the two side walls of the fixing seat 20, and is extended through the oblong hole 27 of the press block 26, so that the adjusting threaded rod 30 is mounted between the fixing seat 20 and the press block 26. The adjusting threaded rod 30 normally meshes with the thread 28 of the oblong hole 27 of the press block 26 by the urging force of the spring 25. The adjusting threaded rod 30 has a first end provided with a rotation knob 31, and a second end provided with a push plate 32.

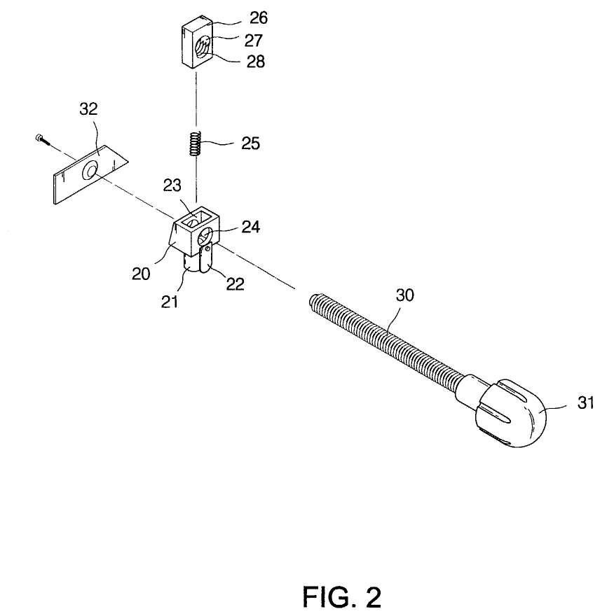

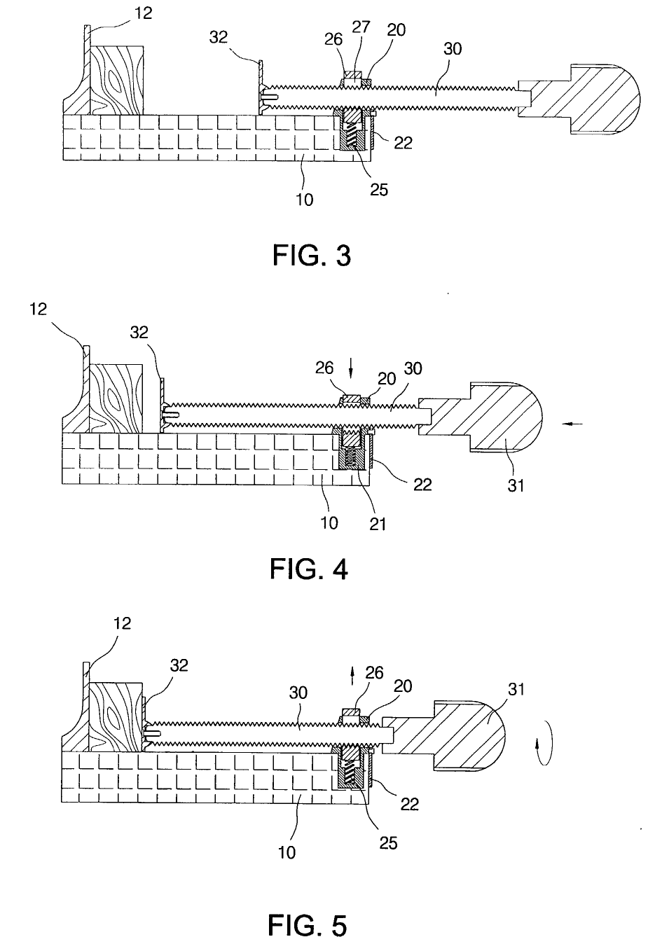

In operation, referring to FIGS. 3-5 with reference to FIGS. 1 and 2, the adjusting threaded rod 30 initially meshes with the thread 28 of the oblong hole 27 of the press block 26 by the urging force of the spring 25 as shown in FIG. 3.

Then, the press block 26 may be pressed downward, to detach the adjusting threaded rod 30 from the thread 28 of the oblong hole 27 of the press block 26, so that the adjusting threaded rod 30 may be moved freely and quickly to push the push plate 32 to move from the position as shown in FIG. 3 to the position as shown in FIG. 4. In such a manner, the adjusting threaded rod 30 may be moved to push the push plate 32 in a macro-adjusting manner.

Then, the pressing force exerted on the press block 26 may be removed, so that the press block 26 may be moved upward by the restoring force of the spring 25, and the adjusting threaded rod 30 may again mesh with the thread 28 of the oblong hole 27 of the press block 26 by the urging force of the spring 25. Thus, the adjusting threaded rod 30 may be rotated and moved relative to the press block 26, so as to push the push plate 32 to move from the position as shown in FIG. 4 to the position as shown in FIG. 5, so as to urge the workpiece, so that the workpiece may be clamped between the push plate 32 and a catch plate 12, thereby facilitating the workpiece being cut. In such a manner, the adjusting threaded rod 30 may be rotated and moved to push the push plate 32 in a micro-adjusting manner.

Thus, when the press block 26 is not pressed, the press block 26 may be moved upward by the restoring force of the spring 25, and the adjusting threaded rod 30 may mesh with the thread 28 of the oblong hole 27 of the press block 26 by the urging force of the spring 25. Thus, the adjusting threaded rod 30 may be rotated and moved at a slower speed, so as to adjust the adjusting threaded rod 30 in a micro-adjusting manner, so that the push plate 32 may urge the workpiece exactly, thereby facilitating the user cutting the workpiece.

On the other hand, when the press block 26 is pressed downward, the adjusting threaded rod 30 may detach from the thread 28 of the oblong hole 27 of the press block 26, so that the adjusting threaded rod 30 may be moved freely and quickly to push and move the push plate 32 to a determined position according to the size of the workpiece. Thus, the adjusting threaded rod 30 may be moved at a higher speed, so as to adjust the adjusting threaded rod 30 in a macro-adjusting manner, so that the push plate 32 maybe moved to a determined position rapidly, thereby facilitating the user micro-adjusting the adjusting threaded rod 30 to push the push plate 32 to urge the workpiece exactly.

Accordingly, the adjusting threaded rod 30 may be moved freely and quickly in a reciprocating manner to move to a determined position, and may also be micro-adjusted at a slower speed, so that the adjusting threaded rod 30 may be operated rapidly and may be micro-adjusted exactly, so as to urge the workpiece to be cut.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A circular saw having a workpiece clamping device, comprising a base having a top face secured with a fixing seat, and an adjusting threaded rod extended through the fixing seat, wherein:
the fixing seat is formed with a hollow receiving chamber, a press block is movably mounted in the receiving chamber of the fixing seat, and is formed with an oblong hole, the oblong hole of the press block has a bottom formed with a semi-circular thread; and
the adjusting threaded rod is extended through the fixing seat, and is extended through the oblong hole of the press block, the adjusting threaded rod normally meshes with the thread of the oblong hole of the press block.

2. The circular saw having a workpiece clamping device in accordance with claim 1, wherein the top face of the fixing seat is formed with at least one circular hole, and the fixing seat has a bottom provided with a positioning column secured in the circular hole of the base.

3. The circular saw having a workpiece clamping device in accordance with claim 1, wherein the fixing seat has a front end secured with a clamp plate for clamping the fixing seat on a front wall of the base.

4. The circular saw having a workpiece clamping device in accordance with claim 1, wherein the fixing seat has two side walls each formed with a shaft hole communicating with the receiving chamber for passage of the adjusting threaded rod.

5. The circular saw having a workpiece clamping device in accordance with claim 1, further comprising a spring mounted in the receiving chamber of the fixing seat, and is biased between the press block and a wall of the receiving chamber of the fixing seat for pressing the press block upward.

6. The circular saw having a workpiece clamping device in accordance with claim 1, wherein the adjusting threaded rod has a first end provided with a rotation knob, and a second end provided with a push plate.
